(19) United States
(12) Patent Application Publication
(10) Pub. No.: US 2017/0089566 A1
(43) Pub. Date: Mar. 30, 2017

(54) ILLUMINATION ASSEMBLY, AND LIGHT FIXTURE INCLUDING THE SAME

(71) Applicant: WELL SHIN TECHNOLOGY CO., LTD., Taipei City (TW)

(72) Inventor: Jui-Hsiung Wu, Taipei City (TW)

(21) Appl. No.: 14/981,504

(22) Filed: Dec. 28, 2015

(30) Foreign Application Priority Data
Sep. 25, 2015 (TW) 104215580

(51) Int. Cl. F21V 33/00; F21V 29/83; F21V 23/00; F21V 25/12; F21V 29/74; F21V 31/00

(52) U.S. Cl. CPC F21V 33/0052; F21V 29/74; F21V 31/005; F21V 23/009; F21V 25/12; F21V 29/83; F21Y 2115/10

(57) ABSTRACT

A light fixture includes a supporting unit including two supporting arms, and multiple illumination assemblies connected between the supporting arms. Each illumination assembly includes a heat dissipation unit, an illumination module and a controlling module. The heat dissipation unit includes a base plate and multiple fins. The illumination module includes a light-permeable cover unit, and an illumination unit disposed between the cover unit and the base plate. The illumination unit includes multiple illumination elements. The controlling module is mounted to the heat dissipation unit, and includes a box unit and a circuit board unit received in the box unit and coupled to the illumination unit for controlling operation of the illumination elements.

### CROSS-REFERENCE TO RELATED APPLICATION

This application claims priority of Taiwanese Patent Application No. 104215580, filed on Sep. 25, 2015.

### FIELD

The disclosure relates to a light fixture that has a plurality of individually-controllable illumination assemblies.

### BACKGROUND

A conventional light fixture includes a support unit, a plurality of illumination modules and a circuit module. The support unit is used for holding the illumination modules. The circuit module is used for controlling the illumination modules. The size of the support unit is designed according to the size and number of the illumination modules. The luminous intensity of the conventional light fixture is often adjusted by changing the number of the illumination modules. Based on practical requirements, in order to change the luminous intensity of the conventional light fixture, the support unit needs to be redesigned and remade according to the number of the illumination modules, resulting in increased manufacturing costs. Moreover, in changing the number of the illumination modules, it is laborious and inconvenient to install or remove the illumination modules.

Furthermore, when the conventional light fixture is used for street lighting, the luminous intensity of the conventional light fixture cannot be immediately adjusted according to environmental conditions.

### SUMMARY

Therefore, an object of the present disclosure is to provide a light fixture that can alleviate at least one of the aforementioned drawbacks associated with the prior art.

According to the present disclosure, a light fixture includes a supporting unit and a plurality of illumination assemblies. The supporting unit includes two supporting arms. The illumination assemblies are connected between the supporting arms. Each of the illumination assemblies includes a heat dissipation unit, an illumination module and a controlling module. The heat dissipation unit includes a base plate that has a contacting surface and a heat dissipation surface opposite to the contacting surface, and a plurality of fins that are connected to the heat dissipation surface. The illumination module includes a light-permeable cover unit mounted to the contacting surface of the base plate of the heat dissipation unit, and an illumination unit disposed between the cover unit and the base plate. The illumination unit includes a mounting plate and a plurality of illumination elements mounted to the mounting plate for emitting light toward the light-permeable cover unit. The controlling module is mounted to the heat dissipation unit such that the controlling module and the illumination module are located respectively at two opposite sides of the heat dissipation unit. The controlling module includes a box unit and a circuit board unit received in the box unit and electrically coupled to the illumination unit for controlling operation of the illumination elements.

According to the present disclosure, an illumination assembly includes a heat dissipation unit, an illumination module and a controlling module. The heat dissipation unit includes a base plate that has a contacting surface and a heat dissipation surface opposite to the contacting surface, and a plurality of fins connected to the heat dissipation surface. The illumination module includes a light-permeable cover unit mounted to the contacting surface of the base plate of the heat dissipation unit, and an illumination unit disposed between the cover unit and the base plate. The illumination unit includes a mounting plate and a plurality of illumination elements mounted to the mounting plate for emitting light toward the cover unit. The controlling module is mounted to the heat dissipation unit such that the controlling module and the illumination module are located respectively at two opposite sides of the heat dissipation unit. The controlling module includes a box unit and a circuit board unit received in the box unit and electrically coupled to the illumination unit for controlling operation of the illumination elements.

### BRIEF DESCRIPTION OF THE DRAWINGS

Other features and advantages of the present disclosure will become apparent in the following detailed description of the exemplary embodiment with reference to the accompanying drawings, of which:

FIG. 1 is a perspective view of an exemplary embodiment of a light fixture according to the present disclosure;

FIG. 2 is a top view of the exemplary embodiment;

FIG. 3 is a side view of the exemplary embodiment;

FIG. 4 is a bottom view of the exemplary embodiment;

FIG. 5 is an exploded perspective view of two supporting arms, a fixing member and a plurality of illumination assemblies of the exemplary embodiment;

FIG. 6 is a perspective view showing one of the illumination assemblies of the exemplary embodiment;

FIG. 7 is another perspective view of one of the illumination assemblies;

FIG. 8 is an exploded perspective view of one of the illumination assemblies;

FIG. 9 is another exploded perspective view of one of the illumination assemblies;

FIG. 10 is a fragmentary enlarged exploded perspective view of one of the illumination assemblies;

FIG. 11 is another fragmentary enlarged exploded perspective view of one of the illumination assemblies;

FIG. 12 is an exploded perspective view of a controlling module of one of the illumination assemblies; and

FIG. 13 is another exploded perspective view of a controlling module of one of the illumination assemblies.

### DETAILED DESCRIPTION

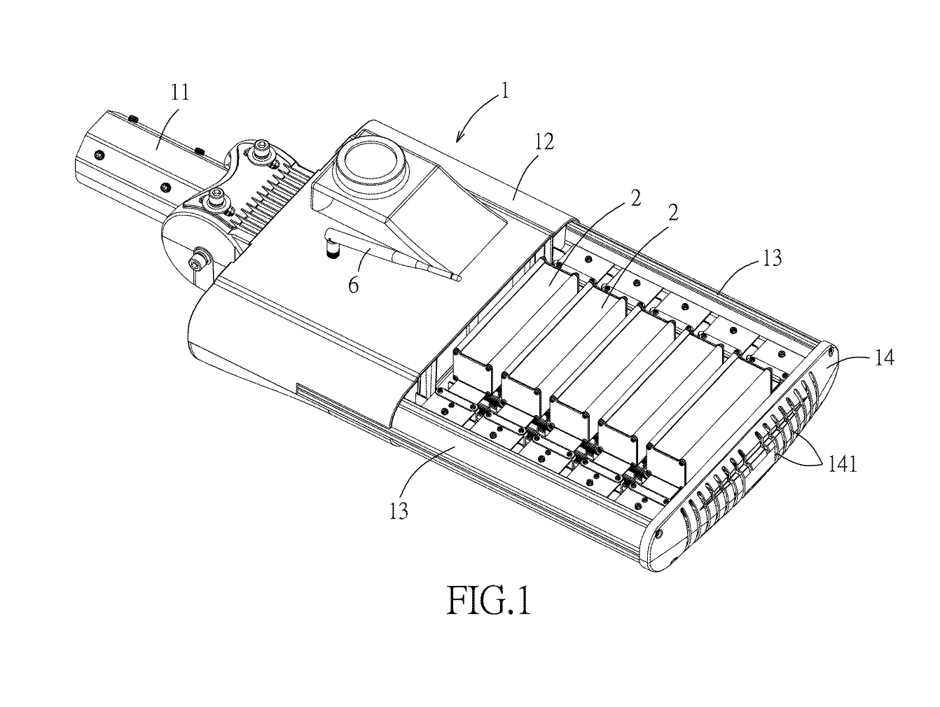

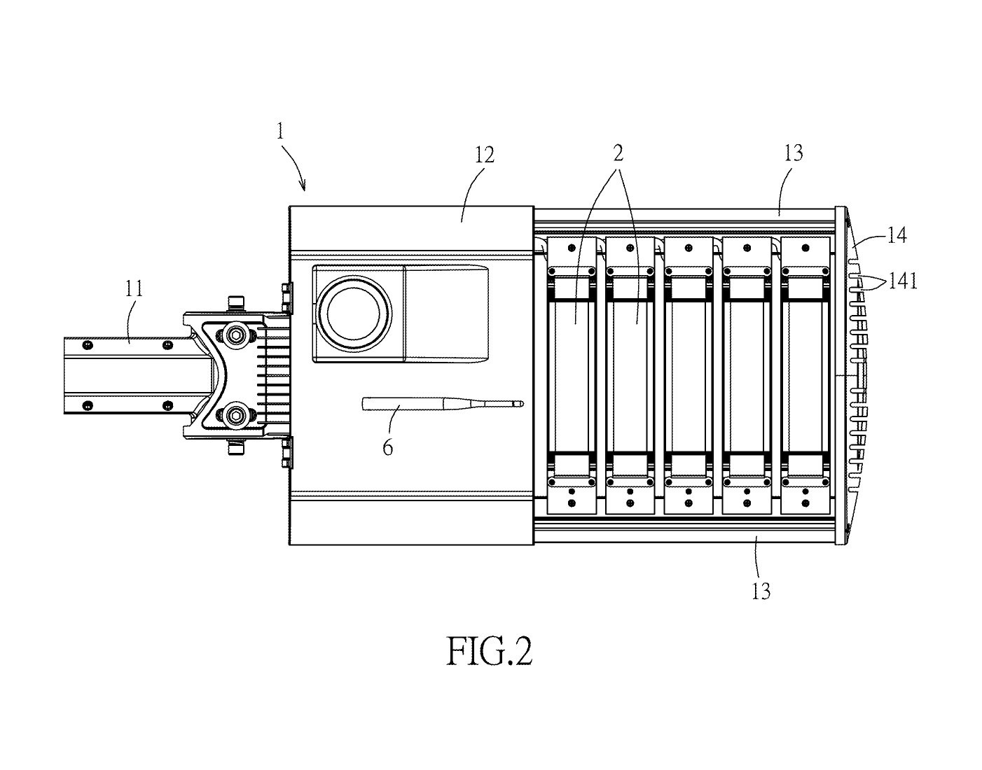

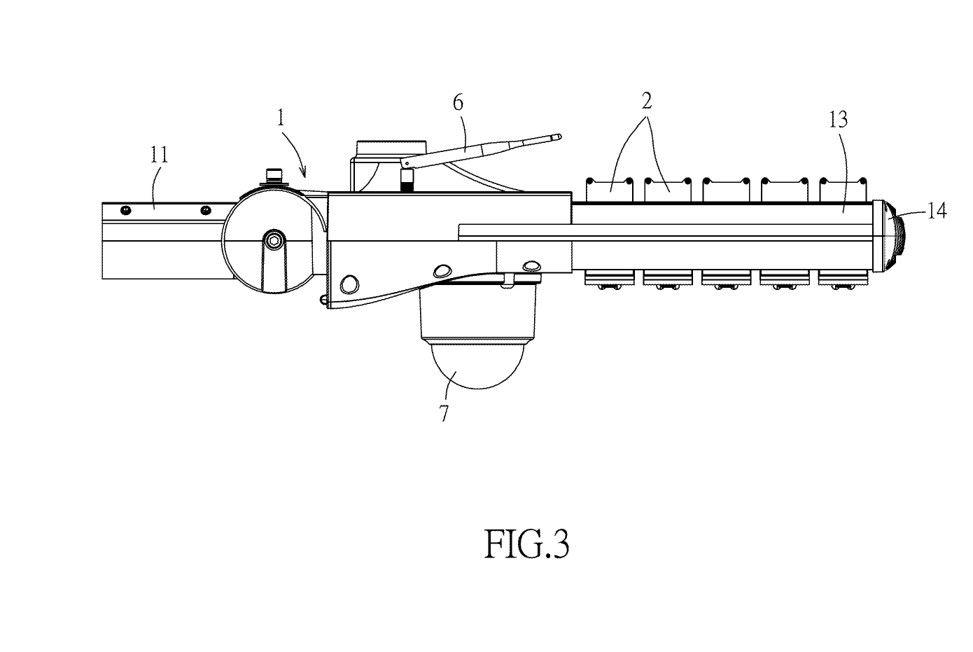

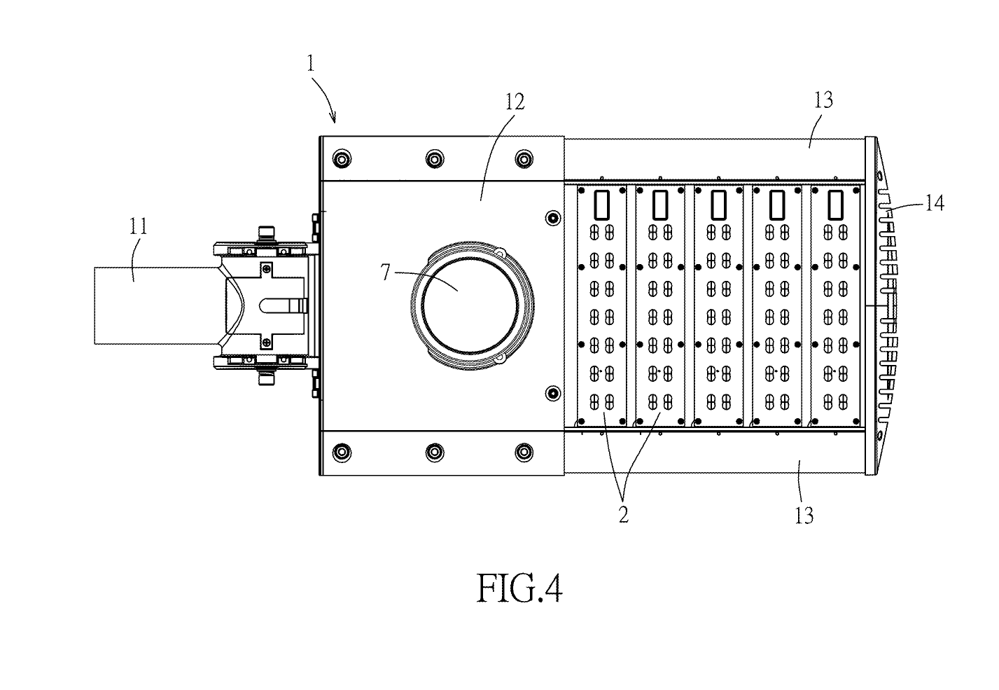

Referring to FIGS. 1 to 5, an exemplary example of a light fixture according to the present disclosure includes a supporting unit 1, a plurality of illumination assemblies 2, a wireless transmission module 6 and an image capturing module 7.

In this embodiment, the light fixture is used for street lighting. However, the light fixture may also be used for other purposes such as indoor lighting. The supporting unit 1 includes a supporting rod 11, a base 12, two supporting arms 13, and a fixing member 14 spaced apart from the base 12. One end of the supporting rod 11 is fixed relative to the ground, and the other end of the supporting rod 11 is connected to the base 12. The supporting rod 11 and the base 12 define an angle therebetween that is adjustable according to practical requirements. The illumination assemblies 2 are connected between the supporting arms 13. The supporting arms 13 interconnect the base 12 and the fixing member 14. According to practical needs, the supporting arms 13 with a desired length can be used. To be more specific: if the number of the illumination assemblies 2 is reduced, the supporting arms 13 with a shorter length will be required; if the number of the illumination assemblies 2 is increased, the supporting arms 13 with a longer length will be required. After formation of the supporting arms 13, each of the supporting arms 13 can be cut into desired lengths based on actual demands (i.e., the number of the illumination assemblies 2). In other words, when adjusting the number of the illumination assemblies 2, only the supporting arms 13 need be replaced according to a required length, and the other elements of the light fixture may remain the same, thereby reducing manufacturing and storage costs, and increasing flexibility in the number of the illumination assemblies 2.

In this embodiment, the number of the illumination assemblies 2 is five. For the sake of brevity, only one of the illumination assemblies 2 is described hereinafter.

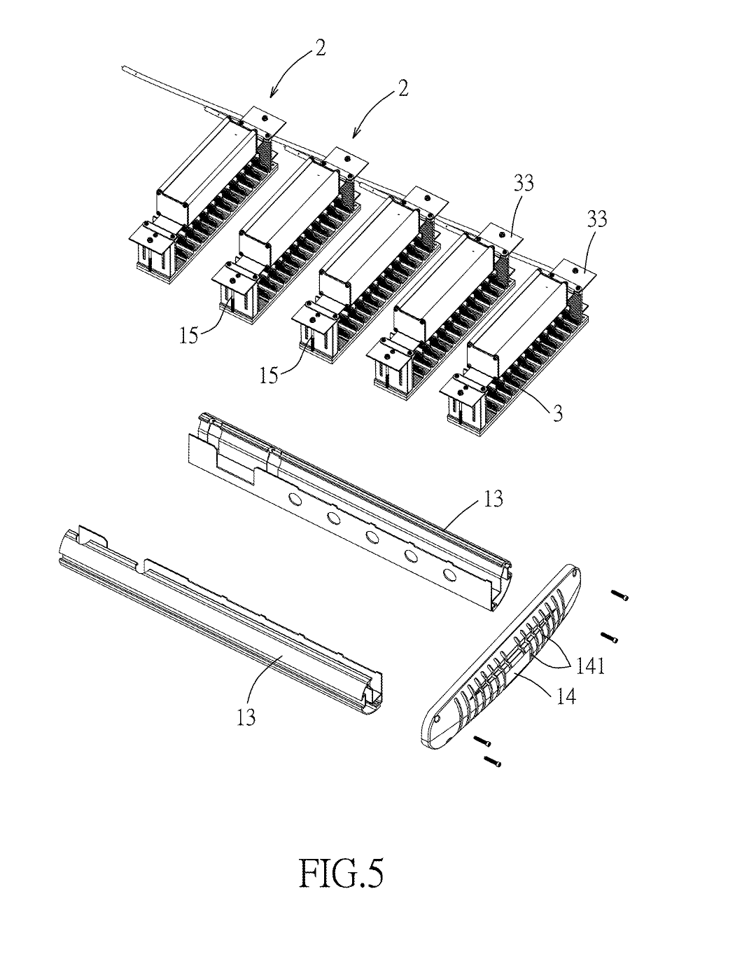

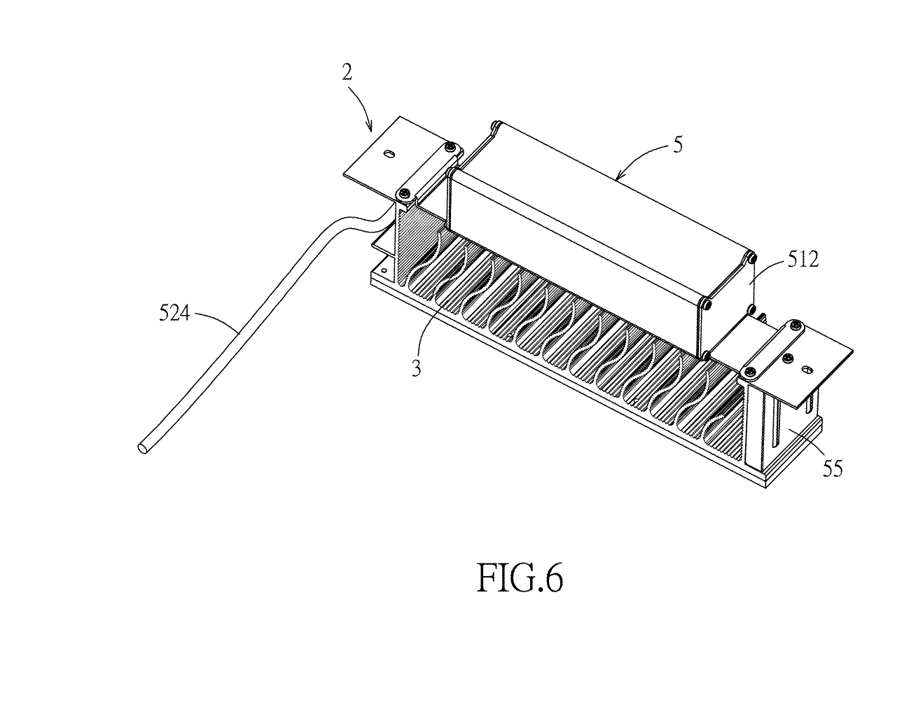

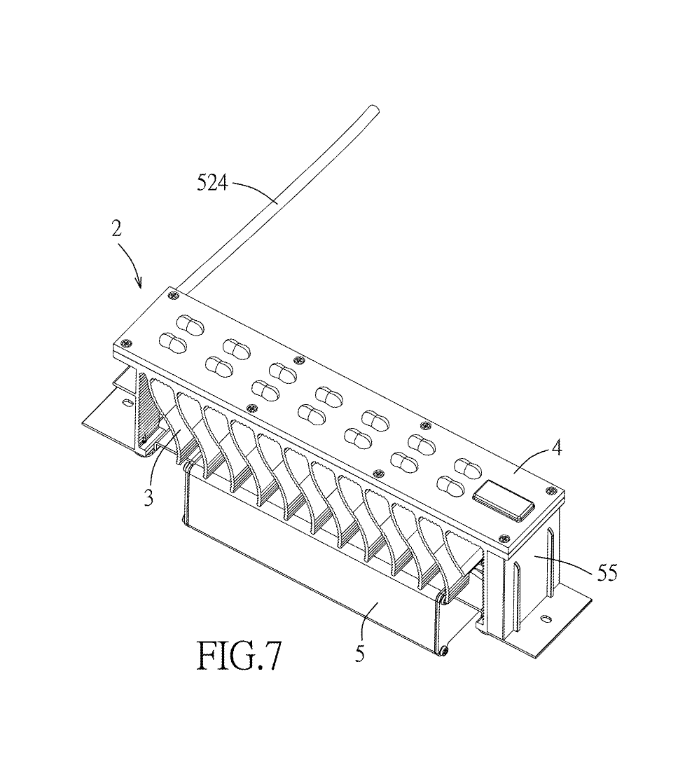

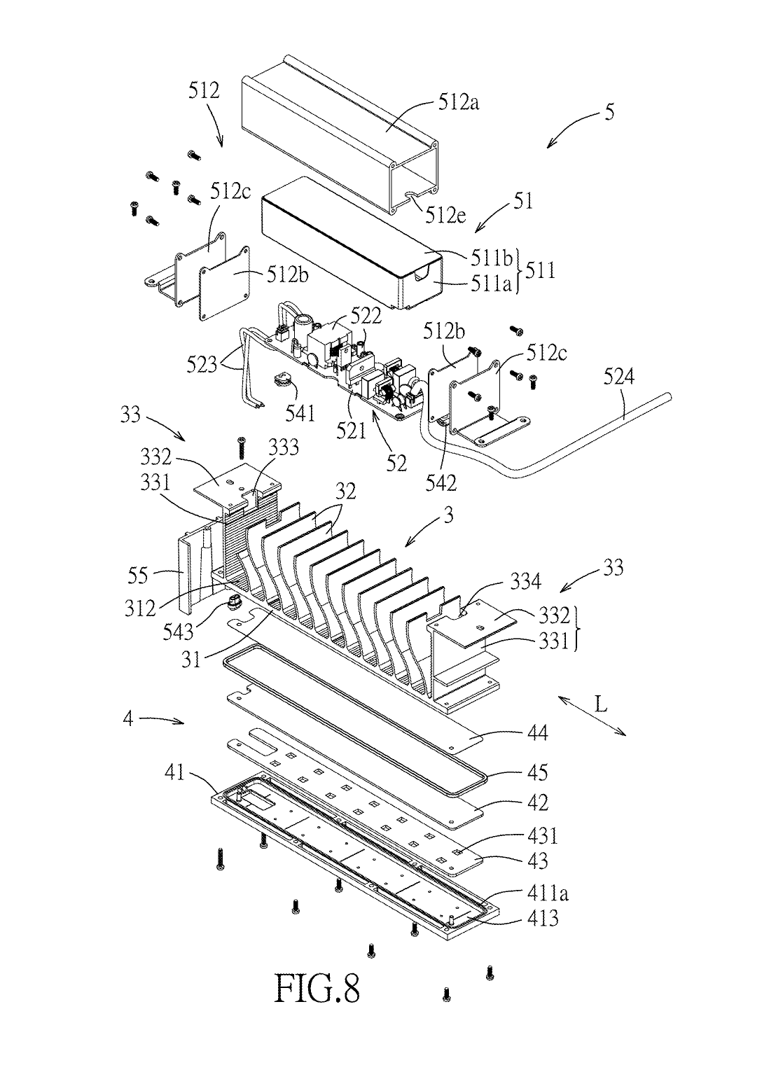

Referring to FIGS. 6 to 9, the illumination assembly 2 includes a heat dissipation unit 3, an illumination module 4 and a controlling module 5. The heat dissipation unit 3 includes a base plate 31 and a plurality of fins 32. The base plate 31 is elongated, and has a contacting surface 311 and a heat dissipation surface 312 opposite to the contacting surface 311. The fins 32 are spaced apart from each other along a longitudinal direction (L) of the base plate 31 (see FIG. 8), and are connected to the heat dissipation surface 312 of the base plate 31. In this embodiment, the heat dissipation unit 3 further includes two connecting members 33 that are disposed respectively at two opposite ends of the base plate 31, that flank the fins 32, and that are respectively connected to the supporting arms 13 of the supporting unit 1 (see FIGS. 1 and 5). Each of the connecting members 33 has a vertical first connecting portion 331 connected to the base plate 31, and a horizontal second connecting portion 332 connected to the vertical first connecting portion 331. In this embodiment, the heat dissipation surface 312 of the base plate 31, the fins 32 and the vertical first connecting portions 331 of the connecting members 33 are formed with a plurality of grooves for enhancing heat dissipation capability of the heat dissipation unit 3. The type, location, and size of the grooves may be changed according to practical requirements.

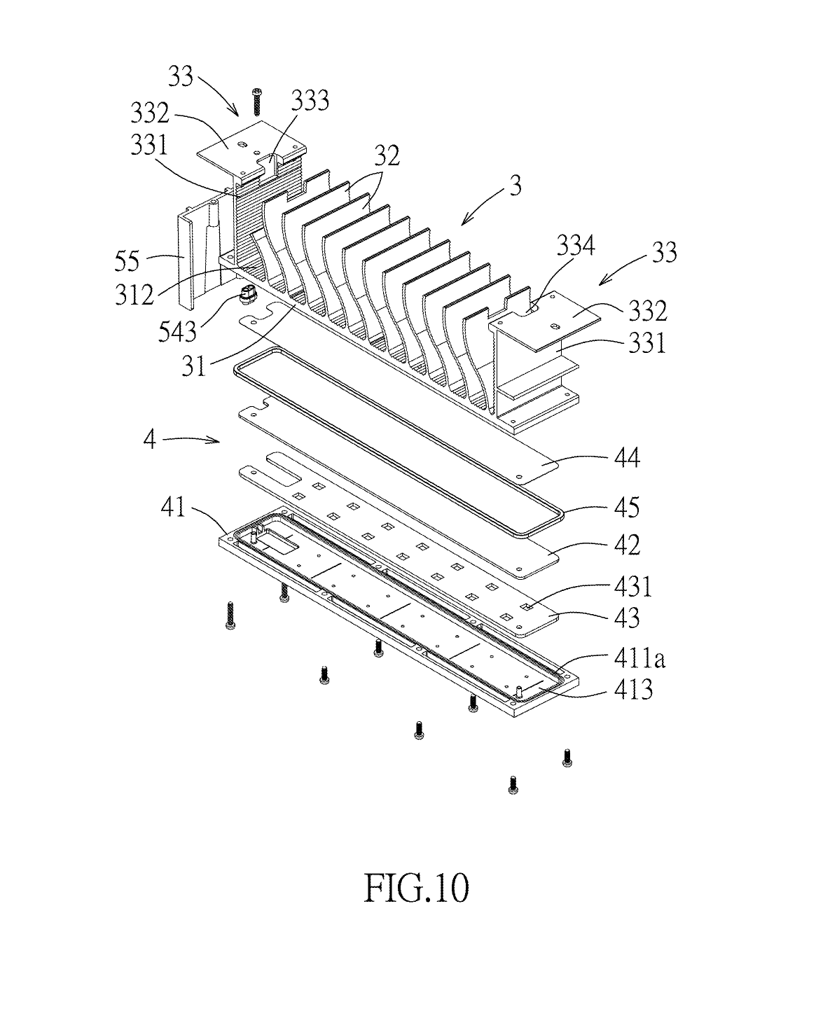

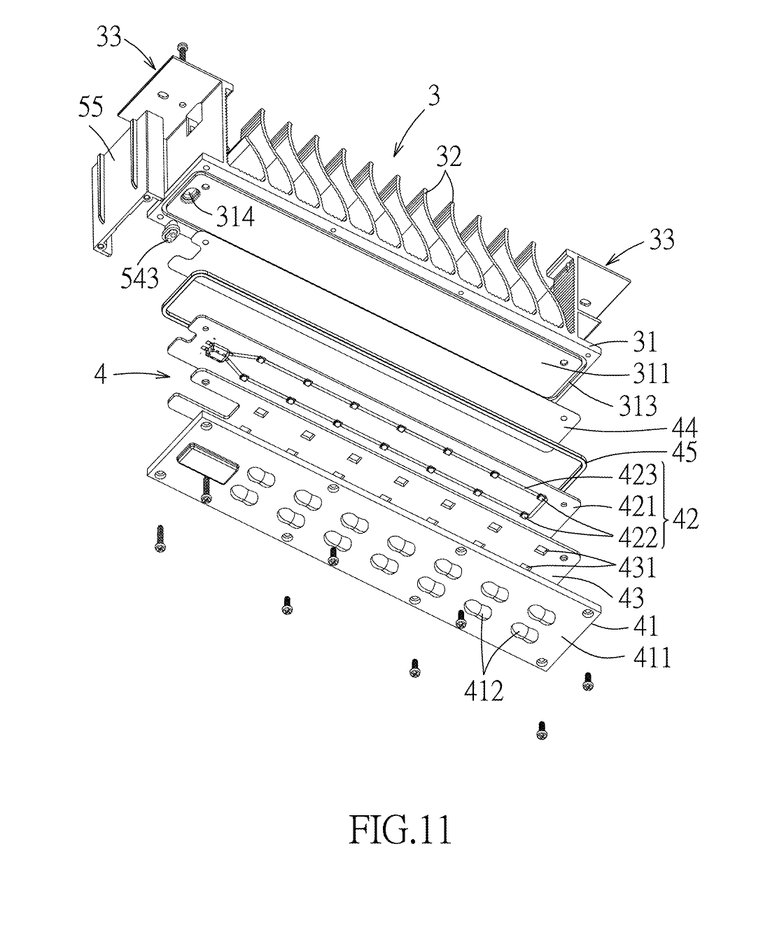

Referring further to FIGS. 10 and 11, the illumination module 4 includes a light-permeable cover unit 41, an illumination unit 42, a fireproof plate 43, a heat transfer plate 44 and a waterproof gasket 45.

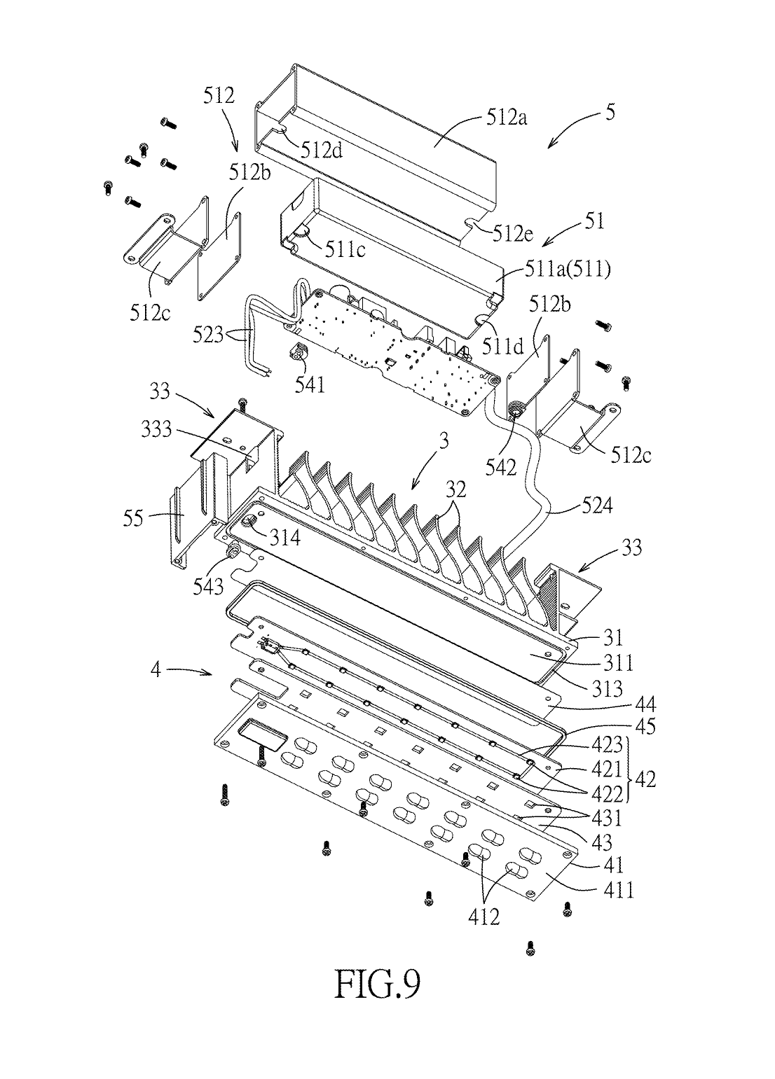

The light-permeable cover unit 41 is mounted to the contacting surface 311 of the base plate 31 of the heat dissipation unit 3. The illumination unit 42 is disposed between the cover unit 41 and the base plate 31, and includes a mounting plate 421 and a plurality of illumination elements 422 mounted to the mounting plate 421 for emitting light toward the light-permeable cover unit 41. The heat transfer plate 44 is disposed between the illumination unit 42 and the base plate 31, and contacts the mounting plate 421 of the illumination unit 42 and the contacting surface 311 of the base plate 31 for transferring heat generated by the illumination elements 422 to the heat dissipation unit 3. The fireproof plate 43 is disposed between the light-permeable cover unit 41 and the illumination unit 42, is light-permeable, and is formed with a plurality of through-holes 431 that respectively correspond in position to the illumination elements 422 of the illumination unit 42 for exposing the illumination elements 422 to the light-permeable cover unit 41. The fire proof plate 43 prevents a circuitry 423 (see FIGS. 9 and 11) of the illumination unit 42 from contacting the light-permeable cover unit 41 and enables the illumination assembly 2 to meet fireproof standards. The light-permeable cover unit 41 has a body 411 and a plurality of lenses 412. The body 411 is formed with a recess 413 for receiving the illumination unit 42, the fireproof plate 43 and the heat transmission plate 44 therein. The lenses 412 protrude from a side surface of the body 411 opposite to the recess 413, and respectively correspond in position to the illumination elements 422. The body 411 of the light-permeable cover unit 41 is formed with a first annular groove 411a. The base plate 31 of the heat dissipation unit 3 is formed with a second annular groove 313. The first annular groove 411a and the second annular groove 313 correspond in position to each other and cooperatively receive the waterproof gasket 45 therein. The waterproof 45 surrounds the illumination unit 42, the fireproof plate 43 and the heat transfer plate 44. That is, a liquid-tight seal is established between the light-permeable cover unit 41 and the base plate 31 to define a liquid-tight space for receiving the illumination unit 42, the fireproof plate 43 and the heat transfer plate 44 therein. The liquid-tight seal prevents moisture (e.g., moisture from rainfall and fog) from damaging the illumination unit 42.

The illumination elements 422 of the illumination unit 42 may be light-emitting diodes (LEDs). The body 411 of the light-permeable cover unit 41 may be made of a plastic material. The fireproof plate 43 may be made of fireproof glass. The waterproof gasket 45 may be made of an elastic material as long as the waterproof gasket 45 can achieve a liquid-tight purpose.

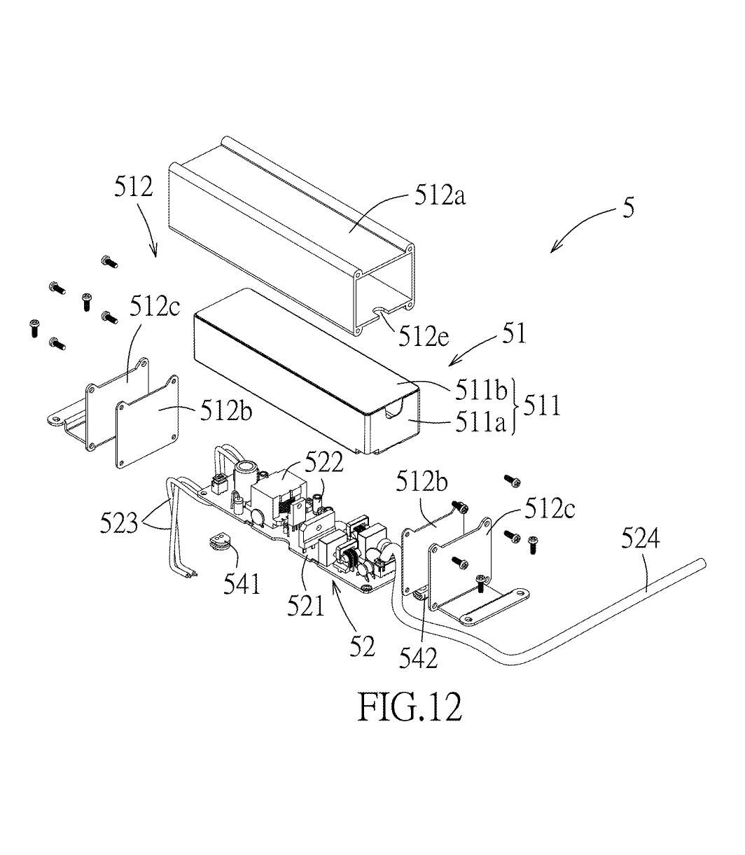

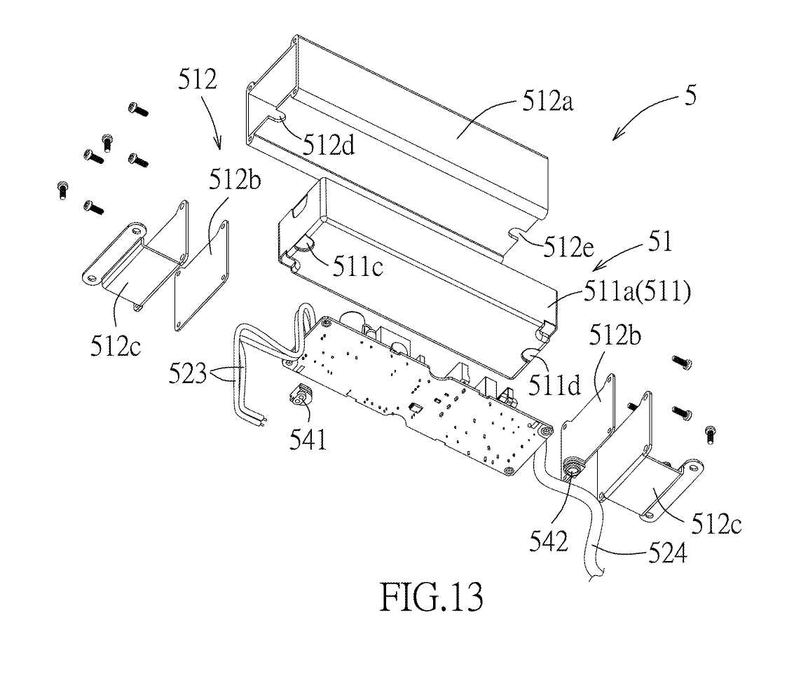

Referring to FIGS. 8, 9, 12 and 13, the controlling module 5 is mounted to the heat dissipation unit 3 such that the controlling module 5 and the illumination module 4 are located respectively at two opposite sides of the heat dissipation unit 3. The controlling module 5 includes a box unit 51 and a circuit board unit 52. The box unit 51 includes an insulating inner box 511 that contains the circuit board unit 52 therein, and a metal outer box 512 that contains the insulating inner box 511 therein and that is connected fixedly to the horizontal second connecting portions 322 of the connecting members 33. The circuit board unit 52 is received in the box unit 51, and is electrically coupled to the illumination unit 42 for controlling operation of the illumination elements 422. In this embodiment, operation of each of the illumination assemblies 2 is individually controllable.

To be more specific, the insulating inner box 511 is made of an insulating material (e.g., plastic), and includes a main body 511a, and a cover body 511b that is connected openably to the main body 511a. The metal outer box 512 includes a tube body 512a, two side covers 512b and two connecting plates 512c. The insulating inner box 511 is received in the tube body 512a of the metal outer box 512, and the side covers 512b are respectively screwed to two opposite ends of the tube body 512a to seal the insulating inner box 511. Each of the connecting plates 512c consists of a vertical section and a horizontal section to form a substantial L-shape. The vertical section of each of the connecting plates 512c has a shape corresponding to that of a respective one of the side covers 512b of the metal outer box 512, and is screwed to a respective one of the two opposite ends of the tube body 512a. The horizontal section of each of the connecting plates 512c is screwed to the horizontal second connecting portion 332 of a respective one of the connecting members 33 to fix the box unit 51 to the heat dissipation unit 3. The circuit board unit 52 includes a circuit board 521, a plurality of electronic components 522 mounted on the circuit board 521, two conducting wires 523, and a cable 524. The circuit board 521 and the electronic components 522 are disposed on the insulating inner box 511 to prevent the circuit board 521 and the electronic components 522 from contacting the metal outer box 512 which would otherwise cause short circuit and leakage of electricity. The main body 511a of the insulating inner box 511 is formed with a first through hole 511c and a second through hole 511d. The tube body 512a of the metal outer box 512 is formed with a third through hole 512d and a fourth through hole 512e. The connecting members 33 are respectively formed with a fifth through hole 333 and a sixth through hole 334. The base plate 31 is formed with a seventh through hole 314. The first, third, fifth and seventh through holes 511c, 512d, 333, 314 correspond in position to each other for the conducting wires 523 to pass therethrough. The second, fourth and sixth through holes 511d, 512e, 334 correspond in position to each other for passage of the cable 524 therethrough. A first elastic liquid-tight plug 541 is provided to be plugged into the first and third through holes 511c, 512d, and seal a space between the conducting wires 523 and the first and third through holes 511c, 512d. A second elastic liquid-tight plug 543 is provided to be plugged into the seventh through hole 314, and seal a space between the conducting wires 523 and the seventh through hole 314. A third elastic liquid-tight plug 542 is provided to be plugged into the second and third through holes 511d, 512e, and seal a space between the cable 524 and the second and third through holes 511d, 512e. The first and second elastic liquid-tight plugs 541, 543 prevent liquid or moisture from entering the insulating inner box 511 through the second and third through holes 511d, 512e, thereby protecting the circuit board unit 52 against damage caused by the liquid or moisture. The second elastic liquid-tight plug 543 prevents liquid or moisture from entering the liquid-tight space through the seventh through hole 314, thereby protecting illumination unit 42 against damage caused by liquid or moisture. A cover plate 55 is provided to enclose a portion of the conducting wires 523 between the cover plate 55 and a respective one of the connecting members 33, thereby preventing the conducting wires 523 from being dragged, and improving the appearance of the illumination assembly 2.

Referring back to FIGS. 1 to 5, the fixing member 14 corresponds in position to the heat dissipation unit 3 of each of the illumination assemblies 2, and is formed with a plurality of venting holes 141 for enhancing heat dissipation. The illumination assemblies 2 are connected between the supporting arms 13 via a plurality of fixing members 15 (see FIG. 5). The wireless transmission module 6 is mounted to the base 12 and is coupled to the circuit board unit 52 of the controlling module 5 of each of the illumination assemblies 2 for transmitting electric signals and controlling operation of the illumination elements 422. The wireless transmission module 6 may be compatible with various wireless communication protocols and be able to control individual operations of the illumination assemblies 2 according to practical requirements. The image capturing module 7 is mounted to the base 12 and is coupled to the wireless transmission module 6. An image signal captured by the image capturing module 7 is transmittable by the wireless transmission module 6. The image capturing module 7 may be controlled remotely by the wireless transmission module 6 for being used as a surveillance camera. Therefore, the number of independently-installed surveillance cameras on a street can be reduced.

To sum up, the light fixture of this disclosure includes the illumination assemblies 2 that are individually controllable. The number of the illumination assemblies 2 can be changed according to practical requirements, and the supporting arms 13 can be replaced according to a required length without the necessity of changing the other elements of the light fixture, thereby reducing manufacturing and storage costs, and increasing flexibility in the number of the illumination assemblies 2. Moreover, the wireless transmission module 6 is capable of controlling individual operation of the illumination assemblies 2. The image capturing module 7 may be controlled remotely by the wireless transmission module 6 for being used as a surveillance camera, thereby reducing the number of the surveillance cameras that need be independently installed on a street. The functionality of the light fixture is increased with the inclusion of the wireless transmission module 6 and the image capturing module 7.

While the disclosure has been described in connection with what are considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A light fixture comprising:
a supporting unit including two supporting arms; and
a plurality of illumination assemblies connected between said supporting arms, each of said illumination assemblies including:
a heat dissipation unit that includes a base plate having a contacting surface and a heat dissipation surface that is opposite to said contacting surface, and a plurality of fins connected to said heat dissipation surface;
an illumination module that includes a light-permeable cover unit mounted to said contacting surface of said base plate of said heat dissipation unit, and an illumination unit disposed between said light-permeable cover unit and said base plate, said illumination unit including a mounting plate and a plurality of illumination elements that are mounted to said mounting plate for emitting light toward said light-permeable cover unit; and
a controlling module that is mounted to said heat dissipation unit such that said controlling module and said illumination module are located respectively at two opposite sides of said heat dissipation unit, said controlling module including a box unit and a circuit board unit that is received in said box unit and electrically coupled to said illumination unit for controlling operation of said illumination elements.

2. The light fixture as claimed in claim 1, wherein said base plate of said heat dissipation unit is elongated, said fins being spaced apart from each other along a longitudinal direction of said base plate, said heat dissipation unit further including two connecting members that are disposed respectively at two opposite ends of said base plate and that flank said fins, each of said connecting members having a vertical first connecting portion that is connected to said base plate, and a horizontal second connecting portion that is connected to said vertical first connecting portion, said box unit of said controlling module being connected fixedly to said horizontal second connecting portions of said connecting members.

3. The light fixture as claimed in claim 2, wherein said box unit of said controlling module includes an insulating inner box that contains said circuit board unit therein, and a metal outer box that contains said insulating inner box therein and that is connected fixedly to said horizontal second connecting portions of said connecting members.

4. The light fixture as claimed in claim 1, wherein a liquid-tight seal is established between said light-permeable cover unit and said base plate to define a liquid-tight space for receiving said illumination unit therein.

5. The light fixture as claimed in claim 4, wherein said illumination module further includes a fireproof plate disposed between said light-permeable cover unit and said illumination unit, said fireproof plate being light-permeable and being formed with a plurality of through-holes that respectively correspond in position to said illumination elements for exposing said illumination elements to said light-permeable cover unit.

6. The light fixture as claimed in claim 5, wherein said illumination module further includes a heat transfer plate disposed between said illumination unit and said base plate, and contacting said mounting plate of said illumination unit and said contacting surface of said base plate for transferring heat generated by said illumination elements to said heat dissipation unit.

7. The light fixture as claimed in claim 6, wherein said light-permeable cover unit of said illumination module has a body formed with a recess for receiving said illumination unit, said fireproof plate and said heat transmission plate therein, and a plurality of lenses protruding from a side surface of said body opposite to said recess and respectively corresponding in position to said illumination elements.

8. The light fixture as claimed in claim 7, wherein said illumination module further includes a waterproof gasket, said body of said light-permeable cover unit being formed with a first annular groove, said base plate of said heat dissipation unit being formed with a second annular groove, said first annular groove of said body of said light-permeable cover unit and said second annular groove of said base plate corresponding in position to each other and cooperatively receiving said waterproof gasket therein, said fireproof plate and said heat transmission plate being surrounded by said waterproof gasket.

9. The light fixture as claimed in claim 1, wherein said supporting unit further includes a base, a fixing member spaced apart from said base, and a supporting rod connected to said base, said supporting arms interconnecting said base and said fixing member.

10. The light fixture as claimed in claim 9, further comprising a wireless transmission module that is mounted to said base and that is coupled to said circuit board unit of said controlling module for transmitting electric signals and controlling operation of said illumination elements.

11. The light fixture as claimed in claim 10, further comprising an image capturing module that is mounted to said base and that is coupled to said wireless transmission module, an image signal captured by said image capturing module being transmittable by said wireless transmission module.

12. The light fixture as claimed in claim 1, wherein operation of each of said illumination assemblies is individually controllable.

13. An illumination assembly comprising:
a heat dissipation unit that includes a base plate having a contacting surface and a heat dissipation surface that is opposite to said contacting surface, and a plurality of fins connected to said heat dissipation surface;
an illumination module that includes a light-permeable cover unit mounted to said contacting surface of said base plate of said heat dissipation unit, and an illumination unit disposed between said light-permeable cover unit and said base plate, said illumination unit including a mounting plate and a plurality of illumination elements that are mounted to said mounting plate for emitting light toward said light-permeable cover unit; and
a controlling module that is mounted to said heat dissipation unit such that said controlling module and said illumination module are located respectively at two opposite sides of said heat dissipation unit, said controlling module including a box unit and a circuit board unit that is received in said box unit and electrically coupled to said illumination unit for controlling operation of said illumination elements.

14. The illumination assembly as claimed in claim 13, wherein said base plate of said heat dissipation unit is elongated, said fins being spaced apart from each other along a longitudinal direction of said base plate, said heat dissipation unit further includes two connecting members that are disposed respectively at two opposite ends of said base plate and that flank said fins, each of said connecting members having a vertical first connecting portion that is connected to said base plate, and a horizontal second connecting portion that is connected to said vertical first connecting portion, said box unit of said controlling module being connected fixedly to said horizontal second connecting portions of said connecting members.

15. The illumination assembly as claimed in claim 14, wherein said box unit of said controlling module includes an insulating inner box that contains said circuit board unit therein, and a metal outer box that contains said insulating inner box therein and that is connected fixedly to said horizontal second connecting portions of said connecting members.

16. The illumination assembly as claimed in claim 13, wherein a liquid-tight seal is established between said light-permeable cover unit and said base plate to define a liquid-tight space for receiving said illumination unit therein.

17. The illumination assembly as claimed in claim 16, wherein said illumination module further includes a fireproof plate disposed between said light-permeable cover unit and said illumination unit, said fireproof plate being light-permeable and being formed with a plurality of through-holes that respectively correspond in position to said illumination elements for exposing said illumination elements to said light-permeable cover unit.

18. The illumination assembly as claimed in claim 17, wherein said illumination module further includes a heat transfer disposed between said illumination unit and said base plate, and contacting said mounting plate of said illumination unit and said contacting surface of said base plate for transferring heat generated by said illumination elements to said heat dissipation unit.

19. The illumination assembly as claimed in claim 18, wherein said light-permeable cover unit of said illumination module has a body formed with a recess for receiving said illumination unit, said fireproof plate and said heat transmission plate therein, and a plurality of lenses that protrude from a side surface of said body opposite to said recess and respectively correspond in position to said illumination elements.

20. The illumination assembly as claimed in claim 19, wherein said illumination module further includes a waterproof gasket, said body of said light-permeable cover unit being formed with a first annular groove, said base plate of said heat dissipation unit being formed with a second annular groove, said first annular groove of said body of said light-permeable cover unit and said second annular groove of said base plate corresponding in position to each other and cooperatively receiving said waterproof gasket therein, said fireproof plate and said heat transmission plate being surrounded by said waterproof gasket.
